(19) United States
(12) Patent Application Publication
(10) Pub. No.: US 2026/0079456 A1
(43) Pub. Date: Mar. 19, 2026

(54) SYSTEM AND METHOD FOR A COGNITIVIE ARCHITECTURE UTILIZED IN MANUFACTURING

(71) Applicant: Robert Bosch GmbH, Stuttgart (DE)

(72) Inventors: Siyu Wu, Centre County, PA (US); Alessandro Oltramari, Pittsburgh, PA (US)

(21) Appl. No.: 18/888,659

(22) Filed: Sep. 18, 2024

(51) Int. Cl. G05B 13/04; G05B 13/02; G06N 3/092

(52) U.S. Cl. CPC G05B 13/04; G05B 13/027; G06N 3/092

(57) ABSTRACT

A computer-implemented method includes receiving, at a neural network, input data indicating one or more tasks associated with production, wherein the neural network is integrated with cognitive architecture that includes an imaginal memory buffer, utilizing the input data indicating one or more tasks with one or more production rule sets associated with an expert decision, obtain goal data indicating the expert decision utilizing imaginal memory buffer, selecting, from the imaginal memory buffer, one or more sectors associated with goal data indicating the novice decision, goal data indicating the intermediate decision, and goal data indicating the expert decision to obtain data indicating decision-making results, and in response to meeting a convergence threshold utilizing the data indicating decision-making results, outputting a simulation associated with a recommendation indicating information associated with at least the input data indicating one or more tasks associated with production.

### TECHNICAL FIELD

The present disclosure relates to a cognitive architecture, including a machine learning network associated with reasoning systems.

### BACKGROUND

Industry 4.0 aims to create “intelligent factories” where advanced manufacturing technologies enable smart decision-making through real-time communication and cooperation among humans, machines, and sensors. Smart scheduling, which leverages advanced models and algorithms using sensor data, exemplifies one such solution.

A value stream map (VSM) is an essential tool in smart scheduling. It serves as a sophisticated flowchart that visualizes and controls the production line. VSM meticulously tracks metrics like inputs, outputs, processes, overall equipment effectiveness (OEE), and cycle times-all crucial for quality and efficiency analysis in production control. However, plant managers face significant challenges in using VSM in production management. These challenges include difficulty applying VSM concepts to complex, real-world scenarios characterized by a high number of intertwined variables. This complexity consistently impedes plant decision-makers from making timely and optimal decisions regarding both time reduction and maintaining stable quality on the production lines.

### SUMMARY

According to a first embodiment, a method includes receiving, at a neural network, input data indicating one or more tasks associated with production, wherein the neural network is integrated with a cognitive architecture that includes an imaginal memory buffer, utilizing the input data indicating one or more tasks with one or more production rule sets associated with an expert decision, obtain goal data indicating the expert decision utilizing imaginal memory buffer, utilizing input data indicating the one or more tasks with one or more production rule sets associated with an intermediate decision, obtain goal data indicating the intermediate decision utilizing imaginal memory buffer, utilizing input data indicating the one or more tasks with one or more production rule sets associated with an novice decision, obtain goal data indicating the novice decision utilizing imaginal memory buffer, selecting, from the imaginal memory buffer, one or more sectors associated with goal data indicating the novice decision, goal data indicating the intermediate decision, and goal data indicating the expert decision to obtain data indicating decision-making results, and in response to meeting a convergence threshold associated with the neural network utilizing the data indicating decision-making results, outputting a simulation associated with a recommendation indicating information associated with at least the input data indicating one or more tasks associated with production.

According to a second embodiment, A computer-implemented method includes receiving, at a neural network, input data indicating one or more tasks associated with production, wherein the neural network is integrated with a cognitive architecture that includes an imaginal memory buffer, utilizing the input data indicating one or more tasks with one or more production rule sets associated with an expert decision, obtain goal data indicating the expert decision utilizing imaginal memory buffer, selecting, from the imaginal memory buffer, one or more sectors associated with goal data indicating the novice decision, goal data indicating the intermediate decision, and goal data indicating the expert decision to obtain data indicating decision-making results, and in response to meeting a convergence threshold utilizing the data indicating decision-making results, outputting a simulation associated with a recommendation indicating information associated with at least the input data indicating one or more tasks associated with production.

According to a third embodiment, a system discloses a neural network, a cognitive architecture, and one or more processors, wherein the processors are programmed to receive, at the neural network, input data indicating one or more tasks associated with production, wherein the neural network is integrated with the cognitive architecture that includes an imaginal memory buffer, utilizing the input data indicating one or more tasks with one or more production rule sets associated with an expert decision, obtain goal data indicating the expert decision utilizing imaginal memory buffer, utilizing input data indicating the one or more tasks with one or more production rule sets associated with an intermediate decision, obtain goal data indicating the intermediate decision utilizing imaginal memory buffer, utilizing input data indicating the one or more tasks with one or more production rule sets associated with an novice decision, obtain goal data indicating the novice decision utilizing imaginal memory buffer, select, from the imaginal memory buffer, one or more sectors associated with goal data indicating the novice decision, goal data indicating the intermediate decision, and goal data indicating the expert decision to obtain data indicating decision-making results, and in response to meeting a convergence threshold utilizing the data indicating decision-making results, output a simulation associated with a recommendation indicating information associated with at least the input data indicating one or more tasks associated with production.

### BRIEF DESCRIPTION OF THE DRAWINGS

FIG. 1 shows a system for training a neural network.

FIG. 2 depicts a data annotation system to implement a system for annotating data.

FIG. 3 discloses an overview system architecture diagram of an embodiment utilizing a cognitive neuro-symbolic reasoning framework.

FIG. 4 is an embodiment of a flow chart of processing input to obtain an output utilizing a system according to one embodiment.

FIG. 5 depicts a schematic diagram of an interaction between computer-controlled machine and control system.

FIG. 6 depicts a schematic diagram of the control system configured to control a manufacturing machine, such as a punch cutter, a cutter or a gun drill, of manufacturing system, such as part of a production line.

FIG. 7 illustrates an embodiment of an expertise level mechanism in VSM-ACT-R.

FIG. 8A depicts an embodiment of production rules control structure for decision making and utilizing of ACT-R goal and imaginal buffers.

FIG. 8B depicts an embodiment of production rules control structure for expert decision making and utilizing of ACT-R goal and imaginal buffers.

FIG. 9 depicts an embodiment of a VSM-ACT-R Model output.

FIG. 10 depicts a graph of decision types over trials with SD shown as shaded fill.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The era of Industry 4.0 demands innovative solutions to produce high-quality products within tight lead times. The embodiment discloses and discusses the integration of cognitive architectures (CAs) into manufacturing solutions, with a focus on using value stream map adaptive cognitive architecture (VSM-ACT-R), a cognitive model built upon the ACT-R architecture. VSM-ACT-R aids in making informed decisions in smart scheduling that boosts productivity while ensuring consistent quality. The model stands out in three key aspects of decision-making in manufacturing: First, it executes tasks using decision making algorithms and knowledge representations observed in human subjects, supported by declarative memories that reflect intuitive and domain-specific knowledge. Second, it mimics various levels of decision making—from novice through to expert—using production rules and retrieval mechanisms that replicate variations of human behavior. Third, it simulates the learning processes of decision-makers, managed by a decision-choice control center that is driven by utility learning and reinforcement reward.

The disclosure includes embodiments that propose a novel approach to address these challenges by integrating cognitive architectures into decision-making processes for manufacturing. Specifically, it employs a cognitive architecture to build models representing decisions and their process related to boosting productivity and ensuring consistent quality. This model leverages data derived from the VSM and decision-makers at Bosch plants.

Cognitive architectures (CAs) aim to create a unified model of the mind using invariant mechanisms to simulate and explain human behavior. CAs use task-specific knowledge to generate behavior. They represent various types of knowledge, including declarative (factual), procedural (how-to), and in recent advancements, perception and motor skills. This knowledge allows CAs to not only simulate behavior but also explain it, both through direct examination and by tracing the reasoning steps involved in real-time (concurrent protocol).

The disclosure may utilize starts from prototypical decision processes distilled by plant managers of Bosch. Their insights, combined with a VSM tailored to their specific plant system, inform the build of our VSM-ACT-R model to enhance decision making. It then introduces the developed VSM-ACT-R model, which stands out in decision-making tasks with three key strengths. First, the model can execute tasks using decision-making behaviors observed in humans and retrieve knowledge representations similarly. This capability is achieved through incorporating declarative memories that cater to intuition and professional knowledge from human subjects.

Second, the model integrates personas ranging from novice to intermediate and expert levels. This is achieved through developed sets of production rules that mimic the behavior of decision-makers at various expertise levels, coupled with retrieval mechanisms for full or partial knowledge representation.

Third, the model simulates the learning processes of decision-makers, transitioning from novice to expert. This simulation is facilitated by the decision-choice control center, which manages error-making, learning, and memory through utility learning and reinforcement rewards. This approach creates a realistic and dynamic decision-making simulation, making the VSM-ACT-R model a robust tool in cognitive architecture-facilitated decision-making in manufacturing.

A system and method may be used for formulating a domain-specific decision problem for optimal production efficiency, leveraging VSM (VSM) to define efficiency sectors and then abstracting the problem for mathematical modeling. The VSM depicts a prototypical manufacturing production line workflow from supplier to customer. Key components include Body Production, Pre-Assembly, Assembly, Honing, Washing, Testing, and Packaging. Later stages are interconnected via First-In-First-Out (FIFO) processes. Metrics displayed for each stage include Cycle Time (CT), Overall Equipment Effectiveness (OEE), and Mean Absolute Error (MAE). The flow progresses through each stage, aiming for efficient operation, performance monitoring, and error minimization to ensure high-quality production output and timely customer delivery.

Focusing on maintaining stable output for the plant, the system and method may consider the plant managers' feedback alongside the Value Stream Map (VSM) structure to develop a decision-making problem that aims to reduce total assembly time while minimizing the increase in defect rate. In one example, there may be a task. The task may be that the manufacturing line has two sections with potential defect sources: pre-assembly and assembly. Pre-assembly takes 40 seconds with an OEE rate of 88%, while assembly takes 44 seconds with an OEE rate of 80.1%. To reduce total assembly time by 4 seconds, the system may need to identify which section can be shortened with minimal defect increase. There are two options: reduce pre-assembly time or reduce assembly time.

This section starts with capturing intuition and domain knowledge from decision makers, followed by the model structure and learning mechanism, and concludes by examining a model output snippet from one run of our VSM model. The model, built upon the prototypical decision process distilled by, for example, Bosch plant managers, incorporates how cognitive models are designed for different levels of expertise. For novices, the model utilizes intuitive deliberative chunks to make decisions. For intermediates, it understands key metrics such as cycle time (CT) and Overall Equipment Effectiveness (OEE). However, intermediates often lack the ability to systematically analyze how these metrics interrelate and cumulatively impact efficiency and quality. Experts, on the other hand, make well-informed judgments based on a comprehensive view of all relevant metrics, obtained through Value Stream Mapping (VSM).

The system may be utilize to create chunks representing knowledge from intuitions to professional expertise. These representations are divided into three chunk types: decisions, decision merits, and goals. Decision chunk encodes six slots: reduction time, decision making state (e.g., novice, intermediate, expert), OEE, and CT. The decision merits chunk holds knowledge on weights for sectors, defect increase for sectors, and the difference in defect rate increase between the two. The goal chunk encodes the initial production conditions and the ultimate goal of making the optimal decision.

Three sets of production rules represent the decision-making behaviors of novice, intermediate, and expert decision-makers. These sets comprise a total of 17 rules, each driven by goal-focused objectives across 14 states.

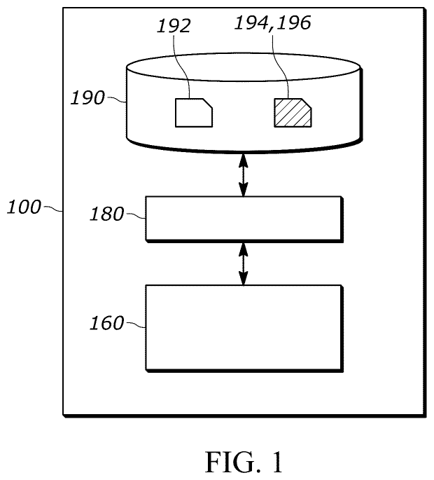

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an Ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. In one embodiment, respective layers of the stack of layers being substituted may have mutually shared weights and may receive, as input, an output of a previous layer, or for a first layer of the stack of layers, an initial activation, and a part of the input of the stack of layers. The system may also include multiple layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 196 of the trained neural network, this data may also be referred to as trained model data 196. For example, as also illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may during or after the training be replaced, at least in part by the data representation 196 of the trained neural network, in that the parameters of the neural network, such as weights, hyper parameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

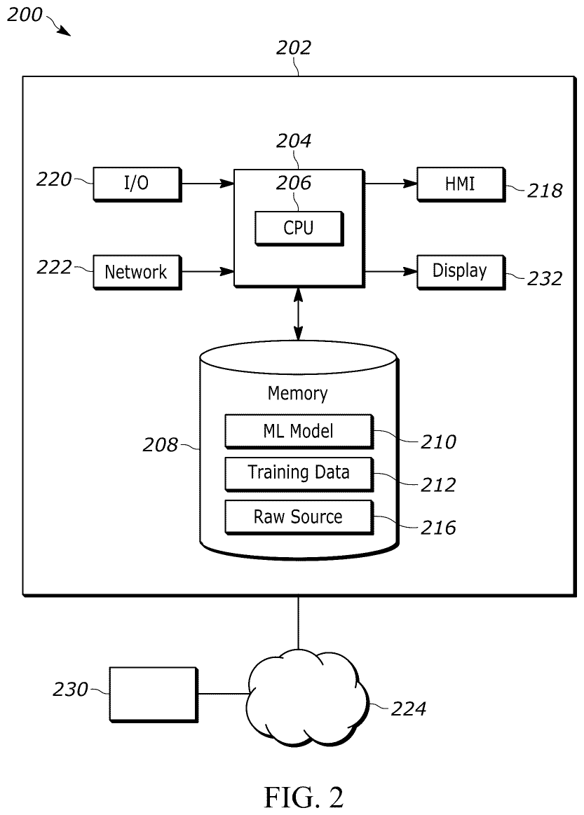

FIG. 2 depicts a data annotation system 200 to implement a system for annotating data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 215.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 215. The raw source dataset 215 may include raw or unprocessed sensor data that may be representative of an input dataset for a machine-learning system. The raw source dataset 215 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 215. The raw source data 215 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 215 to identify the presence of the particular features. The machine-learning algorithm 210 may be configured to identify a feature in the raw source data 215 as a predetermined feature (e.g., pedestrian). The raw source data 215 may be derived from a variety of sources. For example, the raw source data 215 may be actual input data collected by a machine-learning system. The raw source data 215 may be machine generated for testing the system. As an example, the raw source data 215 may include raw video images from a camera.

In the example, the machine-learning algorithm 210 may process raw source data 215 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence may indicate that the machine-learning algorithm 210 has some uncertainty that the particular feature is present.

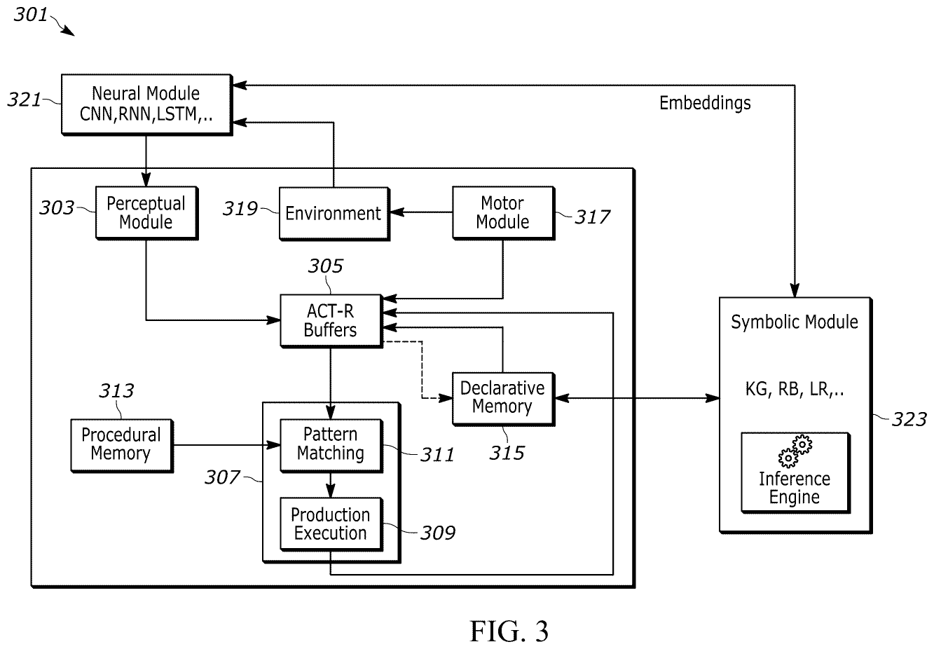

FIG. 3 discloses an overview system architecture diagram of an embodiment utilizing a cognitive neuro-symbolic reasoning framework. Cognitive architectures attempt to capture at the computational level the invariant mechanisms of human cognition, including those underlying the functions of control, learning, memory, adaptively, perception and action, which may be described as ACT-R. ACT-R (Adaptive Control of Thought, Rational), in particular, may be designed as a modular framework including perceptual module 303, motor module 317 and memory components (e.g., procedural memory 313 and declarative memory 315), synchronized by a procedural module 303 through limited capacity buffers (e.g. ACT-R buffers 305).

ACT-R may be a production system that tries to explain human cognition by developing a model of the knowledge structures that underlie cognition. There may be two types of knowledge representation in ACT-R—declarative knowledge and procedural knowledge. Declarative knowledge may correspond to things that a human may be aware of that can be known and can usually describe to others. Examples of declarative knowledge may include “George Washington was the first president of the United States” and “Atoms are made of subatomic particles.” Procedural knowledge may be knowledge which can be displayed in behavior. For example, crossing a street if the traffic light is green for pedestrians is an instance of procedural knowledge. In ACT-R system, declarative knowledge may be represented in structures called chunks whereas procedural knowledge is represented in productions. Thus chunks and productions may be basic building blocks of an ACT-R model.

ACT-R has accounted for a broad range of tasks at a high level of fidelity, reproducing aspects of complex human behavior, from everyday activities like event planning and car driving, to highly technical tasks such as piloting an airplane, and monitoring a network to prevent cyber-attacks. In previous work, ACT-R has been used as a component in pipelines that include either learning algorithms (e.g., biologically-inspired neural networks) or external knowledge. However, there is no system and method that exists, however, to intertwine the cognitive architecture (e.g., ACT-R system 301) with neuro-symbolic methods and structures. As such, an extension may instrumental to enhance AI-systems and enable high-level reasoning.

The basic ACT-R system 301 may include various compensated or sub-components. For example, system 301 may include a perceptual module 303 that communicates with buffers 305. The ACT-R framework may include a production system 307 that includes a pattern matching module 311 and a production execution module 309. The buffers 305 may be the interface between the procedural memory system 313 and the other components (modules) of the ACT-R architecture. For instance in one example, a goal buffer may be an interface to the goal module. Each buffer 305 may hold one chunk at a time, and the actions of a production 309 may affect the contents of the buffers 305. In one embodiment, a buffer may be associated with procedural memory 313 and declarative memory 315 and thus be used for holding the current procedure and one for holding information retrieved from the declarative memory 315.

The integration of the various systems of the ACT-R framework 301 may include three directions of communication with the auxiliary symbolic network 323 and the neural network 321. A first direction may be the knowledge to memory. The symbolic module 323 may include background knowledge graphs (KG) or domain KGs. The symbolic module 323 may also include a lexical resources (LR), rule bases (RB), and a suitable inference engine, etc. The symbolic module 323 may be linked to the declarative memory 315. There may be a two-way integration between the symbolic module as it can be read or written by ACT-R. The written operation may be triggered when populating or pruning world knowledge may be needed as part of a task-execution.

Another direction may be the neural to perception. The neural module 321 may include a neural network. The neural network 321 may include a convolutional neural network, recurrent neural network, long-short-term memory network, etc. The neural network 321 may be trained and tested with raw data processed from the environment. The network 321 may provide relevant patterns of information to the perceptual module 303. The integration may bypass the direction connection holding found in a standard ACT-R system that is present in between the perceptual module 303 and the environment 319.

In the knowledge to neural network direction, the embedding mechanisms may govern knowledge-infusion in the neural network 321. The system may enable knowledge-based contextualization of patterns of information distilled from the environment and utilize it as input for the ACT-R's perceptual module 303.

If the mutual connections between the two proposed modules and ACT-R provide comprehensive knowledge structures along with scalable learning functionalities, they don't-per se-bring about high-level reasoning: this capability emerges from two features of the integrated framework, namely the cognitive architecture's own procedural module and the inference engine in the external symbolic module.

The procedural module 303 may match the content of the other module buffers 305 and coordinates their activity using production rules, which may be ‘condition-action’ pairs tied to the task at hand. Productions may use a utility-based computation to select, from a set of task-specific plausible rules, the single rule that is executed at any point in time. For instance, when building a recommendation system to support a mechanic in troubleshooting a car engine, a relevant scenario that needs to be covered is a vehicle that doesn't start but has power. In such an example, a high-utility production rule may capture the following heuristic: if the engine holds compression well, and the fuel system is working correctly, then check the spark plugs. Data indicating such may be utilized in the system. The conditions in this rule clearly require empirical evidence, as it is often the case when cognitive architectures are applied to real-world problems: in our scenario, such evidence could be actually gathered by a real technician using the recommendation system in a human-machine-teaming fashion, a type of application that would fall under the ‘cognitive model as oracle’ paradigm.

The inference engine in the symbolic module may be used to derive knowledge from assertions in the semantic resource of reference, a well-known feature of symbolic AI systems. What may be important, is that-in the embodiments described herein—this form of logic-based reasoning may have two functions: (1) providing a combination of asserted and inferred knowledge that the cognitive architecture (e.g., ACT-R) declarative memory can process and pass to the production system; and (2) supporting knowledge-infusion into neural modules. In particular, the first functionality helps to decouple basic forms of reasoning, e.g. temporal and spatial, from cognitive assessments performed by the production system on conditional actions. Such features may make the proposed system efficient, as ACT-R productions may not be well-suited for logical reasoning.

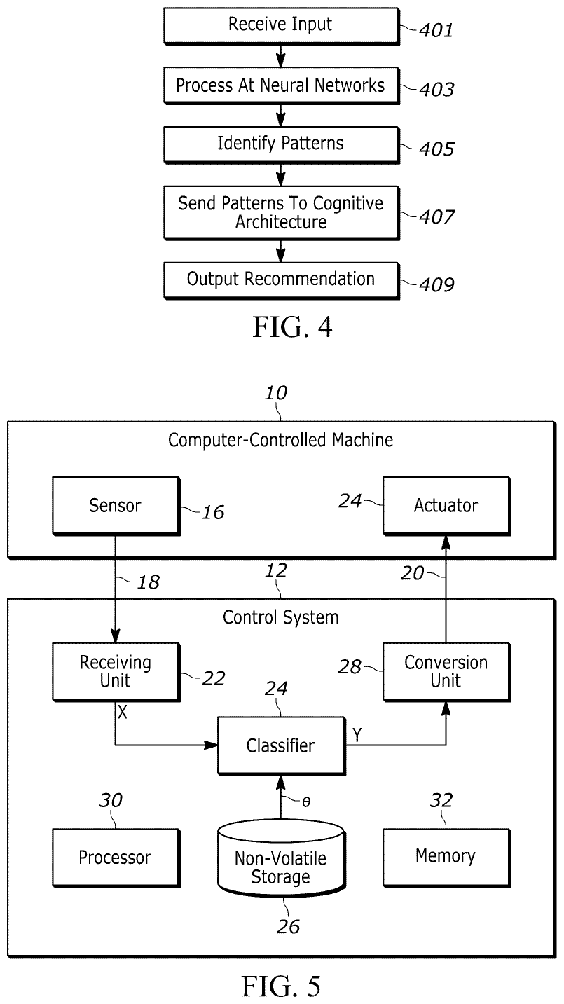

FIG. 4 is an embodiment of a flow chart of processing input to obtain an output utilizing a system according to one embodiment, such as that described in FIG. 3 above. A first step at 401 is that the system may receive an input data. The input data may include a scene that has a vast amount of data utilized by the system. Such data may include video, audio, language (e.g., text) and other information to describe a scene or environment.

At step 403, the input data may be fed into a neural network for processing. The neural network may be a CNN, RNN, or LSTM. The data may be fed until a convergence threshold is met or approached. The data may be analyzed for classifications of the data to identify a scene or environment. For example, the data may be individually analyzed to determine a sound classification. Thus, the audio data may be analyzed. The video data may be identified for classification of the image or images. The language data may also be analyzed to identify a request, or context of the area. In some scenarios the language may include a question or request.

At step 405, the system may identify patterns utilizing the classifications. The system may identify semantic observations from the raw data and create labels. The labels may be utilized to identify events or textual descriptions. An embedding method may be used to infuse semantic structures into the neural network, thus augmenting the identified patterns with context-based knowledge.

At step 407, the patterns may be output from the neural network to the cognitive architecture. Through suitable modular processing orchestrated by a central goal buffer, rule bodies in the production system are matched with patterns and assessed through utility-based functions. The rule with the highest utility value may be selected and utilized.

At step 409, the system may output a recommendation. The recommendation may be processed by the cognitive architecture with the aid of the neural network and the symbolic module. The recommendation may be distilled from the rule head of the rule whose body matches the above mentioned patterns.

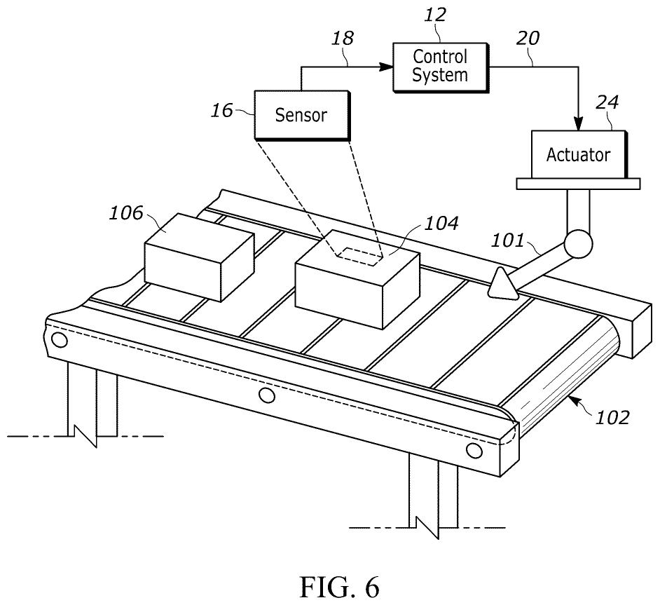

FIG. 5 depicts a schematic diagram of an interaction between computer-controlled machine 10 and control system 12. The computer-controlled machine 10 may include a neural network as described above, such as a network that includes a score prediction network. The computer-controlled machine 10 includes actuator 14 and sensor 16. Actuator 14 may include one or more actuators and sensor 16 may include one or more sensors. Sensor 16 is configured to sense a condition of computer-controlled machine 10. Sensor 16 may be configured to encode the sensed condition into sensor signals 18 and to transmit sensor signals 18 to control system 12. Non-limiting examples of sensor 16 include video, radar, LiDAR, ultrasonic and motion sensors. In one embodiment, sensor 16 is an optical sensor configured to sense optical images of an environment proximate to computer-controlled machine 10.

Control system 12 is configured to receive sensor signals 18 from computer-controlled machine 10. As set forth below, control system 12 may be further configured to compute actuator control commands 20 depending on the sensor signals and to transmit actuator control commands 20 to actuator 14 of computer-controlled machine 10.

As shown in FIG. 5, control system 12 includes receiving unit 22. Receiving unit 22 may be configured to receive sensor signals 18 from sensor 16 and to transform sensor signals 18 into input signals x. In an alternative embodiment, sensor signals 18 are received directly as input signals x without receiving unit 22. Each input signal x may be a portion of each sensor signal 18. Receiving unit 22 may be configured to process each sensor signal 18 to product each input signal x. Input signal x may include data corresponding to an image recorded by sensor 16.

Control system 12 includes classifier 24. Classifier 24 may be configured to classify input signals x into one or more labels using a machine learning (ML) algorithm, such as a neural network described above. The input signal x may include sound information. Classifier 24 is configured to be parametrized by parameters, such as those described above (e.g., parameter θ). Parameters θ may be stored in and provided by non-volatile storage 26. Classifier 24 is configured to determine output signals y from input signals x. Each output signal y includes information that assigns one or more labels to each input signal x. Classifier 24 may transmit output signals y to conversion unit 28. Conversion unit 28 is configured to covert output signals y into actuator control commands 20. Control system 12 is configured to transmit actuator control commands 20 to actuator 14, which is configured to actuate computer-controlled machine 10 in response to actuator control commands 20. In another embodiment, actuator 14 is configured to actuate computer-controlled machine 10 based directly on output signals y.

Upon receipt of actuator control commands 20 by actuator 14, actuator 14 is configured to execute an action corresponding to the related actuator control command 20. Actuator 14 may include a control logic configured to transform actuator control commands 20 into a second actuator control command, which is utilized to control actuator 14. In one or more embodiments, actuator control commands 20 may be utilized to control a display instead of or in addition to an actuator.

In another embodiment, control system 12 includes sensor 16 instead of or in addition to computer-controlled machine 10 including sensor 16. Control system 12 may also include actuator 14 instead of or in addition to computer-controlled machine 10 including actuator 14.

As shown in FIG. 5, control system 12 also includes processor 30 and memory 32. Processor 30 may include one or more processors. Memory 32 may include one or more memory devices. The classifier 24 (e.g., ML algorithms) of one or more embodiments may be implemented by control system 12, which includes non-volatile storage 26, processor 30 and memory 32.

Non-volatile storage 26 may include one or more persistent data storage devices such as a hard drive, optical drive, tape drive, non-volatile solid-state device, cloud storage or any other device capable of persistently storing information. Processor 30 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 32. Memory 32 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 30 may be configured to read into memory 32 and execute computer-executable instructions residing in non-volatile storage 26 and embodying one or more ML algorithms and/or methodologies of one or more embodiments. Non-volatile storage 26 may include one or more operating systems and applications. Non-volatile storage 26 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 30, the computer-executable instructions of non-volatile storage 26 may cause control system 12 to implement one or more of the ML algorithms and/or methodologies as disclosed herein. Non-volatile storage 26 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

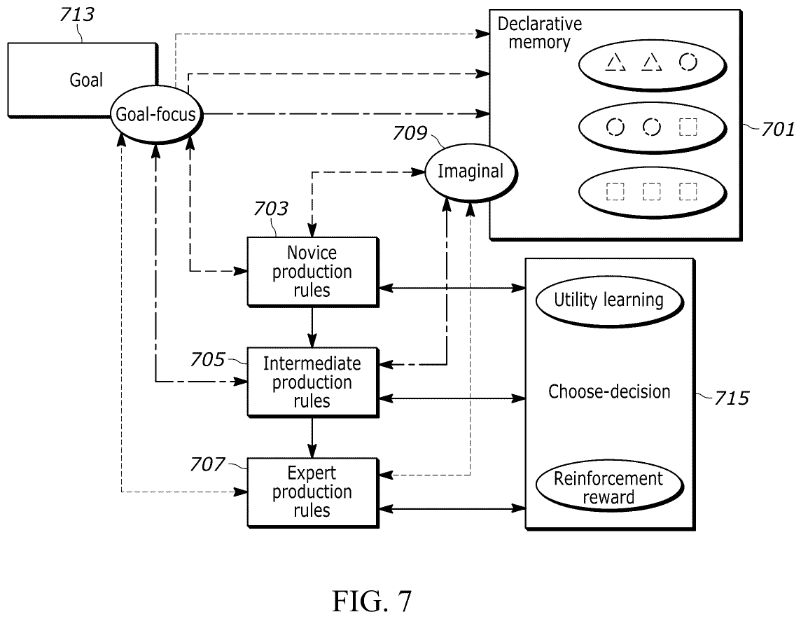

FIG. 6 depicts a schematic diagram of control system 12 configured to control system 101 (e.g., manufacturing machine), such as a punch cutter, a cutter or a gun drill, of manufacturing system 102, such as part of a production line. Control system 12 may be configured to control actuator 14, which is configured to control system 101 (e.g., manufacturing machine).

Sensor 16 of system 101 (e.g., manufacturing machine) may be an optical sensor configured to capture one or more properties of manufactured product 104 or the sensor may be an accelerometer. Classifier 24 may be configured to determine a state of manufactured product 104 from one or more of the captured properties. Actuator 14 may be configured to control system 101 (e.g., manufacturing machine) depending on the determined state of manufactured product 104 for a subsequent manufacturing step of manufactured product 104. The actuator 14 may be configured to control functions of system 101 (e.g., manufacturing machine) on subsequent manufactured product 106 of system 101 (e.g., manufacturing machine) depending on the determined state of manufactured product 104. The control system 12 may utilize the system to help train the machine learning network for adversarial conditions associated with noise utilized by the actuator or an electric drive, such as mechanical failure with parts associated with the production line.

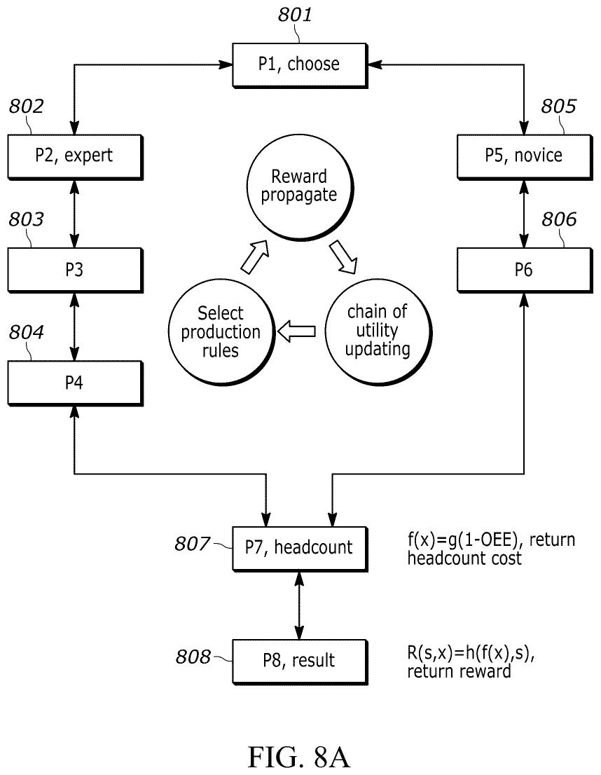

FIG. 7 illustrates an embodiment of an expertise level mechanism in VSM-ACT-R. The cognitive model can learn while performing the tasks through two mechanisms leading to varying levels of expertise. The model may be able to mimic decision-making behavior through differentiating knowledge representations. The model may utilize declarative memories 701 in one embodiment. These memories store knowledge that aligns with human intuition and expertise gained from the VSM. For example, the triangles in the figure represents a portion of the intuition used by novice decision-makers.

In one embodiment, the system may utilize various production rules. The system may include novice production rules 703, intermediate production rules 705, and expert production rules 707. These rules may be utilize to capture the rational decision-making processes observed in human subjects. The dashed lines illustrate how the imaginal buffer 709 retrieves relevant portions of the novice declarative memory 701 and feeds them to the novice production rule set 703. Intermediate and expert decision-making levels follow the same principle. Circles and squares shapes represent their respective declarative memory chunks, and the corresponding dashed arrows (bottom two arrows leading to the declarative memory and imaginal buffer) show the flow of information through their production rule sets. Finally, the goal buffer 713 utilizes the “goal focus” command to manipulate the different phases of the task.

While in one embodiment the model may be used to mimic human behavior, the model also simulates the learning progress achieved by the Decision-Choice Control 715, which manages errors, learning, and memory through utility learning and reinforcement rewards. Novice decision-making, in one embodiment, may start with a utility base and includes a noise setting. The intermediate production rules 705 and expert production rules 707 receive rewards when the corresponding decision-making results are achieved. The utility of these production rules updates is based on the rewards received and the retention of memory, which depends on the time passed since the rule last fired.

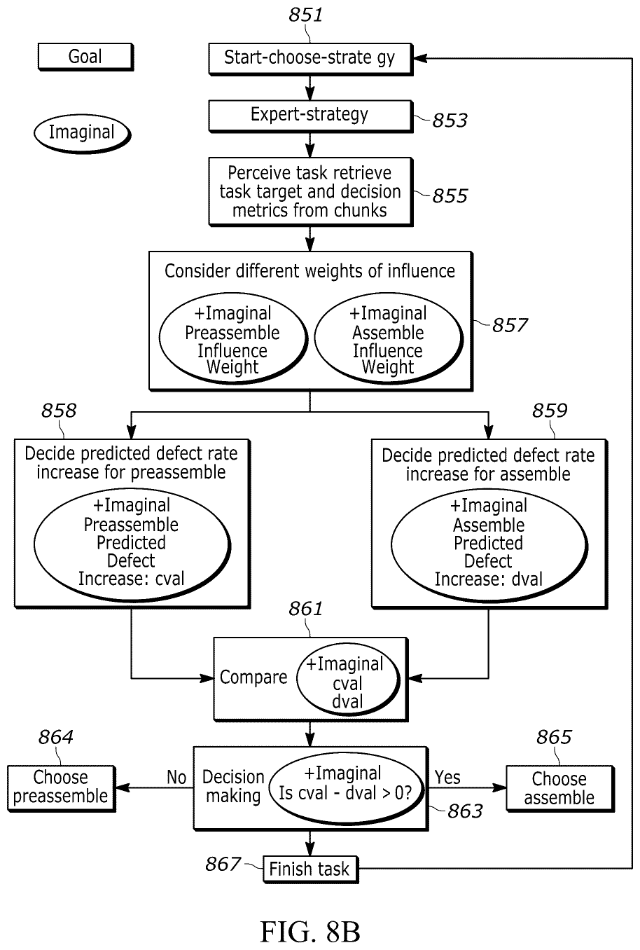

FIG. 8A depicts an embodiment of production rules control structure for decision making and utilizing of ACT-R goal and imaginal buffers. At step 801, the system may select which path to start in a decision making process for a specific tasks that was selected. The process may involve an industrial application for production, or any type of manufacturing. At step 802, the system may perform expert production rules to make a decision. At 802, the production schema may be related to production rules as related to an expert decision-maker in the plant. At step 803 and 804, additional production rules may be evaluated for a specific task. The system may reward and propagate the decisions based on the production rule set for an associated task. Upon evaluating the production rules as associated with a novice at step 805 and any other production rules at step 806, the system may identify tasks associated with the output. At step 807, the system may identify a headcount associated with a production rule set. Thus, a headcount may be needed for a specific task to identify a number of users. At step 808, the system may output the result. The result may indicate a simulation related to the task.

FIG. 8B depicts an embodiment of production rules control structure for expert decision making and utilizing of ACT-R goal and imaginal buffers. In one embodiment, the system may use the expert production rule set as an example, as shown in FIG. 8B. Once the decision-choice center decides to activate this set of expert decision productions, it starts by perceiving the problem and retrieving related decision-making metrics from chunks, as shown in step 855.

At step 857, the system may consider different weights of influence. In one example, the imaginal buffer may have a preassemble influence weight, and in another it may be an assemble influence weight. At step 858, the system may decide a predicted defect rate increase for preassemble option. At 859, the system may decide a predicted defect rate increase for assemble option. At step 861, the system may compare the task utilizing both options to evaluate the optimal option. Thus, the system may determine which embodiment leads to a decrease in issues, defects, or quality. At decision 863, the system may determine utilizing the imaginal buffer whether preassembly or assembly resulted in an increase in points. The system may either decide to select preassembly at 864, or decide to select assembly at 865. Upon the selection, the system may finish the task at step 867.

As such, the imaginal buffer then acts as a temporary workspace, holding and manipulating relevant information during decision making. It allows the cognitive model to build new mental representations or modify existing ones based on incoming data or problem-solving needs. This involves using the imaginal buffer to assess the relationships between the decision target and decision metrics, particularly considering the impact of each sector's weight on the defect rate change, and determining the final defect rate increase for each sector. These results are stored in the imaginal buffer and later retrieved for comparison. This then allows the model to select the sector with the lowest defect increase.

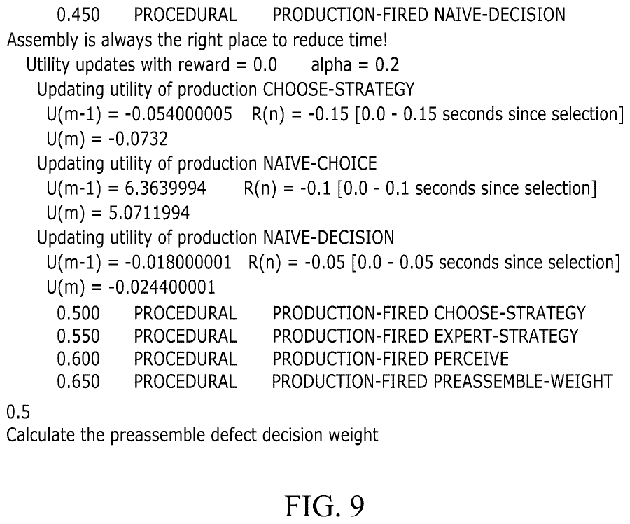

FIG. 9 depicts an embodiment of a VSM-ACT-R Model Output. The partial trace in FIG. 9 shows how the model transitions from naive to more expert-like behaviors. Each production rule's utility is updated based on the reward received and the time since the last selection. For example, the NAIVECHOICE rule's utility decreased from 6.36 to 5.07 due to a reward of −0.1 for the time passed since the last selection. As the utility of naive strategies decreases, the likelihood of the EXPERT-STRATEGY being fired increases.

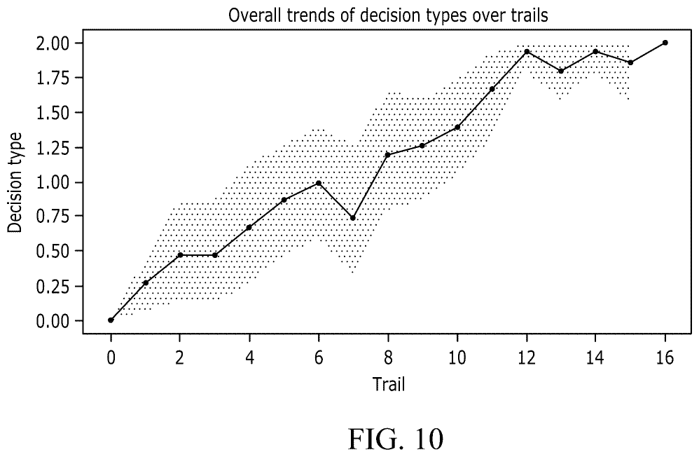

FIG. 10 depicts a graph of decision types over trials with SD shown as gray fill. To answer the question of whether this model learns and how it simulates learning progression and captures individual differences, the system may first use descriptive statistics and linear regression to show the average progression of decision types across 16 trials. The system may then use a mixed linear model to assess and illustrate the effects of trials on decision types across ACT-R model personas, with repeated measures of trials, and random effects to account for individual differences. Finally, the system may use an ordered logistic regression to analyze and understand the relationship between the number of trials and an ordinal dependent variable of learning progress from novice to expert.

In on embodiment, the system and method may run the ACT-R model 15 times to understood its behavior. Each time, the system was asked to run 15-16 trials until the model achieved stable expert behavior. The system collected data with decision types encoded as 0, 1, and 2 for novice, intermediate, and expert strategies. The decision-making data for the runs, acting as ACT-R personas, are shown in FIG. 10 as the average progression of decision types from novice (0) to expert (2) across 16 trials. Starting at approximately 0 in trial 0, the mean decision type rises to about 0.75 by trial 4 and reaches around 1.25 by trial 8. Despite slight fluctuations, the trend continues upward, with the mean decision type approaching 1.75 by trial 12 and around 1.9 by trial 16. The narrowing 95% confidence intervals, ranging from approximately 0.5 to 2.0 initially to 1.5 to 2.0 in later trials, indicate increasing consistency among participants' decision making abilities.

The learning rate, defined as the rate at which decision type progresses from novice (0) to expert (2) across trials, is modeled using a linear regression. This model assumes a constant learning rate across all trials shown in Eqn. 1.

$$y = β \times x + α \qquad Eqn . 1$$

where y is the mean of decision type, x is the trial number, and B (the slope) represents the learning rate. The learning rate for the ACT-R personas is 0.111 with variance of the residuals of 0.026.

The system and method may then use a mixed linear model that includes both fixed and random effects, to assess the effects of trials on decision types, and random effects to account for individual differences. This analysis allows to handling data with nested structures (e.g., multiple trials per personas). In addition, it accounts for the correlation of responses within the same participant and allows for the inclusion of random effects due to individual differences.

TABLE 1
Mixed Linear Model Regression Results

| Dependent Variable: | decision_type | | |
|---|---|---|---|
| No. Observations: | 227 | Method: | REML |
| No. Groups: | 15 | Scale: | 0.4014 |
| Min. group size: | 15 | Log-Likelihood: | \|232.9159 |
| Max. group size: | 16 | Converged: | Yes |
| Mean group size: | 15.1 | | |

| | | Std. | | | | |
|---|---|---|---|---|---|---|
| | Coef. | Err. | z | P > \|z\| | \|.025 | .975\| |
| Intercept | 0.151 | 0.112 | 1.340 | .180 | −0.070 | 0.371 |
| Trial | 0.127 | 0.010 | 13.198 | .000 | 0.108 | 0.146 |
| Group Var | 0.076 | 0.063 | | | | |

The coefficient for the trial may be 0.127 with a p-value of <0.05, indicating a highly significant positive effect of trial on decision type. This suggests that experience or exposure to more trials positively influences the decision-making process, resulting in higher decision type scores. Participants learn or adapt their decision-making strategies over time, becoming more proficient or confident with each subsequent trial.

The random effects component of the model shows a variance of 0.076 for participants, indicating variability in the intercepts across different participants. This variability suggests that while the overall trend shows an increase in decision-type scores with more trials, individual participants start from different baseline levels. In humans, some participants may naturally have higher or lower decision-type scores due to personal characteristics, prior experience, or other unmeasured factors.

The system may then use an ordered logistic regression model without considering individual differences, to analyze the relationship between the number of trials and an ordinal dependent variable of learning progress from novice to expert. This aims to look deeper into how changes in the predictor influence the likelihood of different levels of the ordered outcome in decision-making.

TABLE 2
Ordered Model Regression Results

| Dep. Variable: | decision_type | Log-Likelihood: | −182.40 |
|---|---|---|---|
| Model: | OrderedModel | AIC: | 370.8 |
| Method: | Maximum Likelihood | BIC: | 381.1 |
| No. | 227 | | |
| Observations: | | | |

| | |
|---|---|
| Df Residuals: | 224 |
| Df Model: | 1 |

| | coef. | std err | z | P > \|z\| | \|.025 | .975\| |
|---|---|---|---|---|---|---|
| Trial | 0.3545 | 0.040 | 8.802 | .000 | 0.276 | 0.433 |
| 0/1 | 1.6906 | 0.310 | 5.447 | .000 | 1.082 | 2.299 |
| 1/2 | 0.2262 | 0.139 | 1.631 | .103 | −0.046 | 0.498 |

Table 2 shows that the threshold 0/1 (1.69) with p-value<0.05 indicates a significant cut-off between novice and intermediate categories. The threshold ½ (0.23) is not statistically significant (p-value=0.103), suggesting that the model does not provide strong evidence for a clear separation between intermediate and expert decision types over just 15 trials.

ACT-R personas tend to move to higher decision categories as they undergo more trials, with a significant transition between novice and intermediate, but not as clear a transition between intermediate and expert. The initial learning curve may be steep, however, once personas reach an intermediate level, further improvements become subtler.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method, comprising:
receiving, at a neural network, input data indicating one or more tasks associated with production, wherein the neural network includes a cognitive architecture that includes an imaginal memory buffer;
utilizing the input data indicating one or more tasks with one or more production rule sets associated with an expert decision, obtain goal data indicating the expert decision utilizing imaginal memory buffer;
utilizing input data indicating the one or more tasks with one or more production rule sets associated with an intermediate decision, obtain goal data indicating the intermediate decision utilizing imaginal memory buffer;
utilizing input data indicating the one or more tasks with one or more production rule sets associated with an novice decision, obtain goal data indicating the novice decision utilizing imaginal memory buffer;
selecting, from the imaginal memory buffer, one or more sectors associated with goal data indicating the novice decision, goal data indicating the intermediate decision, and goal data indicating the expert decision to obtain data indicating decision-making results; and
in response to meeting a convergence threshold utilizing the data indicating decision-making results, outputting a simulation associated with a recommendation indicating information associated with at least the input data indicating one or more tasks associated with production.

2. The computer-implemented method of claim 1, wherein each of the production rules update based on data indicating one or more rewards received and retention of memory.

3. The computer-implemented method of claim 1, wherein the convergence threshold is associated with one or more defect rates associated with the one or more tasks.

4. The computer-implemented method of claim 1, wherein the imaginal memory buffer includes an expert imaginal memory buffer, a novice imaginal memory buffer, and an intermediate memory buffer.

5. The computer-implemented method of claim 1, wherein the convergence threshold is associated with a defect rate associated with the production.

6. The computer-implemented method of claim 1, wherein the method includes utilizing 17 production rule sets.

7. The computer-implemented method of claim 1, wherein the method includes utilizing decision chunks to compare defect rates associated with pre-assembly and defect rates associated with assembly.

8. The computer-implemented method of claim 7, wherein one or more weights are associated with pre-assembly or assembly.

9. The computer-implemented method of claim 1, wherein the cognitive architecture is an adaptive control of though rational (ACT-R) architecture configured to utilize a value stream map (VSM).

10. A computer-implemented method, comprising:
receiving, at a neural network, input data indicating one or more tasks associated with production, wherein the neural network is integrated with a cognitive architecture that includes an imaginal memory buffer;
utilizing the input data indicating one or more tasks with one or more production rule sets associated with an expert decision, obtain goal data indicating the expert decision utilizing imaginal memory buffer;
selecting, from the imaginal memory buffer, one or more sectors associated with goal data indicating the novice decision, goal data indicating the intermediate decision, and goal data indicating the expert decision to obtain data indicating decision-making results; and
in response to meeting a convergence threshold utilizing the data indicating decision-making results, outputting a simulation associated with a recommendation indicating information associated with at least the input data indicating one or more tasks associated with production.

11. The method of claim 10, wherein the cognitive architecture is an adaptive control of though rational (ACT-R) architecture.

12. The method of claim 11, wherein the ACT-R architecture is a VSM-ACT-R architecture.

13. The method of claim 10, wherein the cognitive architecture includes procedural module configured to match content of one or more buffers.

14. The method of claim 10, wherein the cognitive architecture includes procedural module configured to coordinate one or more activities using production rules.

15. The method of claim 10, wherein the method includes utilizing declarative memory associated with production rule sets.

16. The method of claim 10, wherein the cognitive architecture is a VSM-ACTR model.

17. A system, comprising:
a neural network;
a cognitive architecture; and
one or more processors, wherein the processor is programmed to:
receive, at the neural network, input data indicating one or more tasks associated with production, wherein the neural network is integrated with the cognitive architecture that includes an imaginal memory buffer;
utilizing the input data indicating one or more tasks with one or more production rule sets associated with an expert decision, obtain goal data indicating the expert decision utilizing imaginal memory buffer;
utilizing input data indicating the one or more tasks with one or more production rule sets associated with an intermediate decision, obtain goal data indicating the intermediate decision utilizing imaginal memory buffer;
utilizing input data indicating the one or more tasks with one or more production rule sets associated with an novice decision, obtain goal data indicating the novice decision utilizing imaginal memory buffer;
select, from the imaginal memory buffer, one or more sectors associated with goal data indicating the novice decision, goal data indicating the intermediate decision, and goal data indicating the expert decision to obtain data indicating decision-making results; and
in response to meeting a convergence threshold utilizing the data indicating decision-making results, output a simulation associated with a recommendation indicating information associated with at least the input data indicating one or more tasks associated with production.

18. The system of claim 17, wherein the cognitive architecture is an adaptive control of though rational (ACT-R) architecture including both procedural memory and declarative memory.

19. The system of claim 17, wherein the declarative memory is configured to store data indicating rules.

20. The system of claim 18, wherein the simulation includes a value stream map (VSM).
